(19) United States
(12) Patent Application Publication
(10) Pub. No.: US 2021/0016470 A1
(43) Pub. Date: Jan. 21, 2021

(54) CURING MOULD LINING

(71) Applicant: COMPAGNIE GENERALE DES ETABLISSEMENTS MICHELIN, CLERMONT-FERRAND (FR)

(72) Inventor: Gaël CHAVATTE, CLERMONT-FERRAND CEDEX 9 (FR)

(21) Appl. No.: 16/766,823

(22) PCT Filed: Nov. 28, 2018
(86) PCT No.: PCT/FR2018/053016

§ 371 Date: May 26, 2020

(30) Foreign Application Priority Data
Nov. 28, 2017 (FR) 1761278

(51) Int. Cl. B29C 33/38; B22D 17/22; B22D 19/00; B29D 30/06

(52) U.S. Cl. CPC B29C 33/3842; B22D 17/22; B29K 2905/02; B29D 30/0606; B29D 2030/0612; B22D 19/00

(57) ABSTRACT

The present invention relates to a device for manufacturing a mould element for moulding a tread by injection of pressurized aluminium, characterized in that it includes a die and a steel counterform, said die and said counterform forming a chamber, and in that the die has slots into which strips are inserted, said slots being wider than the thickness of the strip to enable the strips to come out of the slots when demoulding the mould element from the chamber, and in that the insertion depth of the slots is equal to or less than 25 mm. The chosen width of the slot is a compromise between the hold of the strip during injection of the pressurized aluminium and the ease of demoulding said strip. The slots are blind in order to limit the penetration of the strips, which only project from one side and do not pass through the die.

The present invention relates to the manufacture of a mould element for moulding a tread of a tire.

These mould elements are usually manufactured using a die of friable material, preferably plaster. To remove the die of friable material, the die must be destroyed to release the obtained mould element.

This die includes strips used to form the tread patterns, which solidify in the mould element during moulding. These strips can only be released by destroying the die.

The drawback of using this type of die is that it is a single-use die, which firstly is not environmentally friendly, and secondly approximately twelve such dies are required to make the entire tire mould.

Furthermore, the strips have to remain in place during injection of the aluminium and come away easily when demoulding the mould element. This is even more complex if the aluminium is injected under pressure.

The invention is intended to propose a device and a manufacturing method for a mould element used to mould a tread that is both reusable and that enables strips to be positioned in the mould element while guaranteeing the position of the strips during pressurized injection and the easy removal of the strips when demoulding the mould element.

The device according to the invention is a device for manufacturing a mould element for moulding a tread by injection of pressurized aluminium, characterized in that it includes a die and a steel counterform, said die and said counterform forming a chamber, and in that the die has slots into which strips are inserted, said slots being wider than the thickness of the strip to enable said strips to come out of the slots when demoulding the mould element from the chamber, and in that the slots are blind. The chosen width of the slot is a compromise between the hold of the strip during injection of pressurized aluminium and the ease of demoulding said strip. The slots are blind in order to limit the penetration of the strips, which only project from one side and do not pass through the die.

Advantageously, the width of the slot is between 102% and 150% of the thickness of the strip. This clearance is enough to enable easy demoulding of the strip. For example, the width of the slots can be between +0.01 mm and +0.20 mm, and preferably +0.030 mm and +0.070 mm, greater than the thickness of a strip.

Advantageously, the width of the slot is between 105% and 120% of the thickness of the strip.

Advantageously, the depth of the slots is greater than 4 mm. This minimum depth guarantees the hold of the strip during injection of the aluminium.

Advantageously, the depth of the slots is equal to or less than 25 mm.

Advantageously, the insertion depth of the slots is equal to or less than 12 mm.

Advantageously, the insertion depth of the slots is equal to or less than 8 mm. According to a specific arrangement, the counterform has an aluminium inlet channel arranged behind said counterform. This position is particularly practical for injecting aluminium and leaves the imprint of the inlet channel behind the moulded part, which has no effect on the tread.

Advantageously, the strips are made of steel.

According to a first arrangement, the strips are straight.

According to a second arrangement, the strips are curved.

According to a third arrangement, the strips are corrugated, i.e. said strips comprise a sequence of curves that can be of different heights and that can be longitudinal in relation to the length of the strip. Several strip types may be combined in a single mould.

The invention also relates to a method for manufacturing a mould element for moulding a tread in the device having at least one of the aforementioned features, characterized in that it includes the following steps:
making a steel die,
making slots in the die,
removably inserting strips into the slots,
injecting pressurized aluminium into the chamber.

Advantageously, the slots are made by electro-discharge machining.

Advantageously, the slots are made by laser-assisted machining in a jet of water. Laser-assisted machining in a jet of water is in particular described in patent US 2016/0368090.

Advantageously, the filling pressure of the aluminium is between 20 kN and 150 kN. The filling phase comprises two phases: a first phase in which the fluid is conveyed to a first cavity and the chamber is filled, and a second phase in which the fluid is kept under pressure in the chamber to ensure the chamber is correctly filled, in particular during solidification and to compensate for shrinkage. Once the chamber has been filled, a piston is used to maintain the pressure in the chamber.

Advantageously, the method includes applying a maintenance pressure in the chamber, said maintenance pressure being greater than the filling pressure.

Advantageously, the maintenance pressure of the aluminium is less than 530 kN.

Other advantages may become clear to the person skilled in the art upon reading the examples set out below and illustrated in the attached figures, which are given by way of examples:

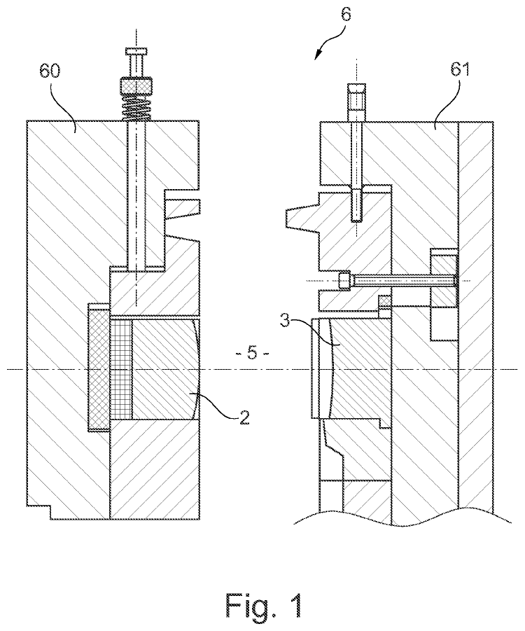

FIG. 1 shows a tool receiving the device for manufacturing a mould element for moulding a tread according to the invention,

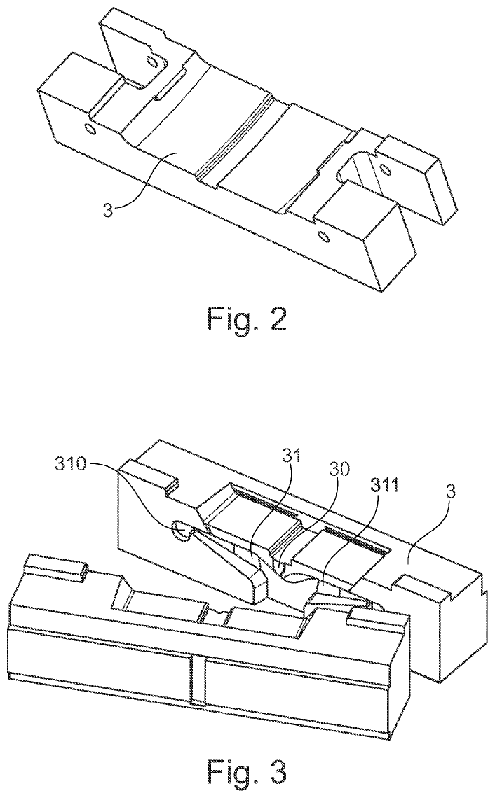

FIG. 2 is a perspective view of an intermediate counterform,

FIG. 3 is a perspective view of a counterform with an aluminium inlet channel,

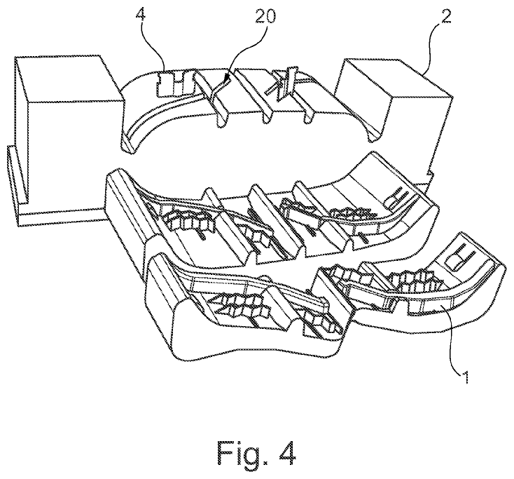

FIG. 4 shows a mould element with a die according to the invention.

The tool 6 shown in FIG. 1 has two portions 60 and 61 that are designed to close onto one another. The portion 60 has a die 2 and the portion 61 has a counterform 3. When the two portions 60 and 61 are joined, the die 2 and the counterform 3 form a chamber 5. This chamber 5 forms the negative shape of the mould element 1

The counterform 3 has an inlet channel 30 arranged behind the counterform 3 (FIG. 3) or to the side (FIG. 2).

The lateral-casting inlet improves filling for complex tread patterns and is easier to automate.

The casting inlet to the rear of the mould is more suited to simple tread patterns. The inlet channel 30 traverses the thickness of the counterform and opens out into the chamber 5.

As shown in FIG. 3, the funnel-shaped inlet channel 30 is preceded by a cavity 31 having a symmetrical shape and two arms 311, each of which terminates in a substantially circular space 310. Upstream shall mean that which is located before in the path of the pressurized aluminium, and downstream shall mean that which is located after. This cavity 31 enables oxides and dirt reaching the feed channel to be collected and stored at the ends of the cavity in the spaces 310.

The die 2 is for example made of steel and has slots 20 into which steel strips 4 are placed. The slots 20 are made by conventional machining, by electro-discharge machining (for example with copper electrodes), by laser-assisted machining or by laser-assisted machining in a jet of water. The dimensions of the slots 20 are such that there is a clearance between the strip 4 and the slot. The slot 20 is wide enough to allow each strip 4 to come out of the slot when demoulding the mould element 1 from the chamber 5, while being narrow enough to hold the strip in place when injecting the pressurized aluminium. The clearance can be between 0.01 mm and 0.20 mm as a function of the size of the strip, and preferably between 0.03 mm and 0.07 mm.

In this description, the strip has a length, a height and a thickness. The strip 20 can be of different shapes: straight, curved or corrugated in the longitudinal direction thereof. The height of the strip can also be variable to form indentations of variable depth in the tread.

The manufacturing method for the mould element 1 comprises the following:
making the steel die 2,
making slots 20 in said die 2,
inserting different types of strip as a function of the desired tread pattern,
making the counterform 3,
placing the die 2 on the portion 60 of the tool 6,
placing the counterform 3 placed on the portion 61 of the tool 6,
closing the tool 6,
injecting pressurized aluminium into the cavity 31, then into the chamber 5 via the channel 30,
once the chamber has been filled, a piston (not shown) is used to keep the aluminium in the chamber 5 under pressure,
allowing to cool for the strips 20 to be set in the aluminium,
demoulding the mould element 1 with the strips 20.

1. Device for manufacturing a mould element for moulding a tread by injection of pressurized aluminium, characterized in that it includes a die and a steel counterform, said die and said counterform forming a chamber, and in that the die has slots into which strips are inserted, said slots being wider than the thickness of the strip to allow said strips to come out of the slots when demoulding the mould element from the chamber, and in that the slots are blind.

2. Device according to claim 1, characterized in that the width of the slot is between 102% and 150% of the thickness of the strip.

3. Device according to claim 1, characterized in that the width of the slot is between 105% and 120% of the thickness of the strip.

4. Device according to claim 1, characterized in that the depth of the slots is greater than 4 mm.

5. Device according to claim 1, characterized in that the depth of the slots is equal to or less than 25 mm.

6. Device according to claim 1, characterized in that the depth of the slots is equal to or less than 12 mm.

7. Device according to claim 1, characterized in that the depth of the slots is equal to or less than 8 mm.

8. Device according to claim 1, characterized in that the counterform has an aluminium inlet channel arranged behind said counterform.

9. Device according to claim 1, characterized in that the strips are made of steel.

10. Device according to claim 1, characterized in that the strips are straight.

11. Device according to claim 1, characterized in that the strips are curved.

12. Device according to claim 1, characterized in that the strips are corrugated.

13. Method for manufacturing a mould element for moulding a tread in the device according to claim 1, characterized in that it includes the following steps:
making a steel die,
making slots in the die,
removably inserting strips into the slots,
injecting pressurized aluminium into the chamber.

14. Method according to claim 13, characterized in that the slots are made by electro-discharge machining.

15. Method according to claim 13, characterized in that the slots are made by laser-assisted machining in a jet of water.

16. Method according to claim 13, characterized in that the filling pressure of the aluminium in the chamber is between 20 kN and 150 kN.

17. Method according to claim 13, characterized in that said method includes applying a maintenance pressure in the chamber, and in that said maintenance pressure is greater than the filling pressure.

18. Method according to claim 17, characterized in that the maintenance pressure in the chamber is less than 530 kN.
